(19) United States
(12) Patent Application Publication
(10) Pub. No.: US 2006/0112517 A1
(43) Pub. Date: Jun. 1, 2006

(54) Hinge assembly for foldable electronic device

(75) Inventors: Pu Luo, Shenzhen (CN); Hui Wang, Shenzhen (CN); Xue-Long Niu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Tu-cheng City (TW)

(21) Appl. No.: 11/285,475

(22) Filed: Nov. 21, 2005

(30) Foreign Application Priority Data
Nov. 27, 2004 (CN) 200420102006.1

(51) Int. Cl. E05D 11/10

(52) U.S. Cl. 16/330

(57) ABSTRACT

A hinge assembly (100) includes a can (10), a fixed cam (20), a sliding cam (40), a compression spring (50), a fixing member (60), and a shaft (30). The can has a center cavity (1031) and a board (103) provided at one end thereof. The fixed cam has a central hole (204) and a groove. The fixed cam is partly received in the can and the board of the can is engaged in the groove. The sliding cam abuts the fixed cam. The sliding cam has a center cavity (403). The compression spring is interposed between the sliding cam and the fixing member. A first end of the shaft is engaged with the fixed cam, and extends the hole of the fixed cam, the cavity of the can, the cavity of the sliding cam and the compression spring. The fixing member is fixed to an second end of the shaft.

### CROSS-REFERENCE TO RELATED APPLICATION

Relevant subject matter is disclosed in co-pending U.S. patent application entitled “HINGE MECHANISM FOR FOLDABLE ELECTRONIC DEVICE”, assigned to the same assignee with this application.

### FIELD OF THE INVENTION

The present invention generally relates to hinge assemblies, and more particularly to a hinge assembly for hinging together housings of foldable electronic devices such as mobile telephones, electronic notebooks, and so on.

### BACKGROUND

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the body. The other housing, called the cover, normally contains fewer electronic components than the body. Other foldable electronic devices have all the electronics in the body, with the cover containing no electronics and serving only to cover a keypad and a display of the body. Various types of hinge assemblies are used to join a body and a cover of a foldable electronic device, so that the cover can unfold up from and fold down upon the body.

As represented in FIG. 7, a conventional small-size hinge assembly includes a shaft 1, a can 2, a fixed cam 3, a rotary sliding cam 4, a compression spring 5, and a fixing member 6. The shaft 1 is provided with a discoid head 11 at a first end portion thereof. An opposite second end portion of the shaft 1 is extended through the can 2, the fixed cam 3, the rotary sliding cam 4, the compression spring 5 and the fixing member 6 in that order, thereby integrating the hinge assembly into a complete unit.

The fixed cam 3, the rotary sliding cam 4, and the compression spring 5 are received in the can 2. A cam face of the fixed cam 3 is engaged with a cam face of the rotary sliding cam 4. The fixing member 6 is secured at the second end portion of the shaft 1. The compression spring 5 is elastically engaged around the shaft 1 between the rotary sliding cam 4 and the fixing member 6, and continuously presses the rotary sliding cam 4 against the fixed cam 3. The fixed cam 3 is rotatable with the can 2, and is rotatable relative to the shaft 1. The rotary sliding cam 4 is axially movable along the shaft 1 and rotatable with the shaft 1, and is rotatable relative to the fixed cam 3. However, the fixed cam 3 may axially move relative to the can 1. This may result in the hinge assembly being unstable.

What is needed, therefore, is a hinge assembly which is compact and stable.

### SUMMARY

In a preferred embodiment herein, a hinge assembly for a foldable electronic device is provided. The hinge assembly includes a can, a fixed cam, a sliding cam, a fixing member, a spring member, and a shaft. The can has a center cavity and a board provided at one end thereof. The fixed cam has a central hole and a groove defined in a periphery thereof. The fixed cam is partly received in the can and the board of the can is engaged in the groove. The sliding cam abuts the fixed cam and is movably engaged therewith. The sliding cam has a center cavity. The spring member is interposed resiliently between the sliding cam and the fixing member. A first end of the shaft is engaged with the fixed cam. The first end of the shaft extends the hole of the fixed cam, the cavity of the can, the cavity of the sliding cam and the spring member. The fixing member is fixed to an opposite second end of the shaft.

Other advantages and novel features of the embodiments will become more apparent from the following detailed description thereof when taken in conjunction with the accompanying drawings, in which:

### BRIEF DESCRIPTION OF THE DRAWINGS

FIG. 1 is a top plan view of a foldable electronic device with a hinge assembly according to a preferred embodiment of the present invention, showing the foldable electronic device in a closed position;

FIG. 2 is an exploded, isometric view of the hinge assembly of FIG. 1, the hinge assembly including a fixed cam;

FIG. 3 is an enlarged, isometric view of the fixed cam of the hinge assembly of FIG. 2;

FIG. 4 is an enlarged, assembled view of the hinge assembly of FIG. 2, showing the hinge assembly positioned corresponding to the closed position of the foldable electronic device;

FIG. 5 is a cross-sectional view taken along line V-V of FIG. 4;

FIG. 6 is similar to FIG. 5, but showing the hinge assembly positioned corresponding to an open position of the foldable electronic device; and

FIG. 7 is an exploded, isometric view of a conventional hinge assembly.

### DETAILED DESCRIPTION OF THE PREFERRED EMBODIMENTS

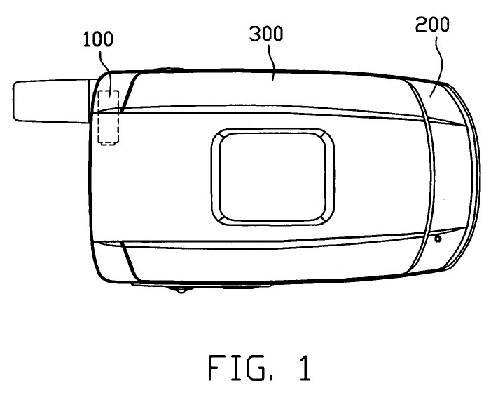

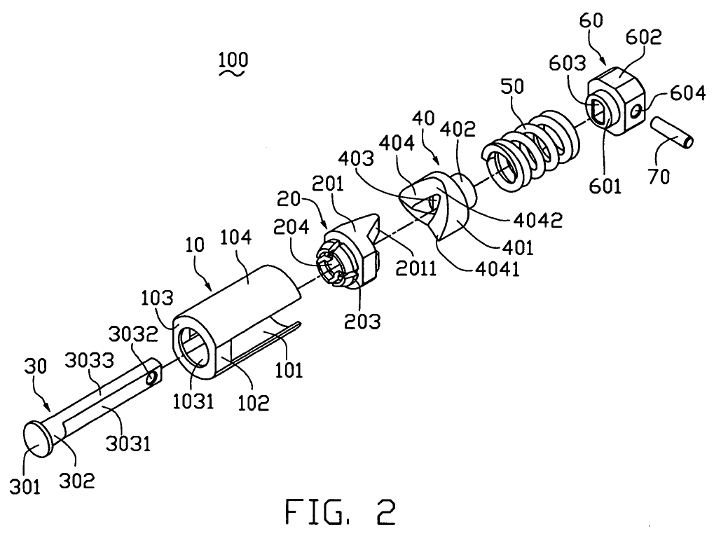

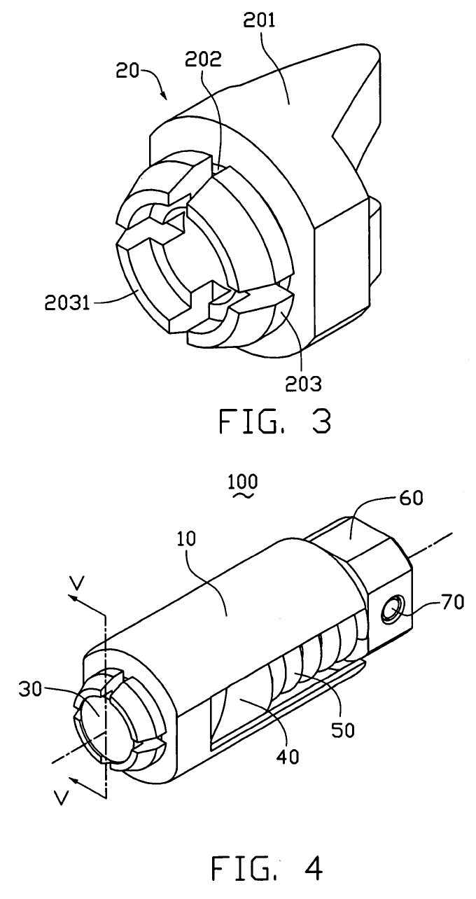

FIGS. 1 and 4 show a hinge assembly 100 according to a preferred embodiment of the present invention, which is used to interconnect a body 200 and a cover 300 of a foldable electronic device. Also referring to FIGS. 2-3, the hinge assembly 100 includes a shaft 30, a can 10, a fixed cam 20, a rotary sliding cam 40, a compression spring 50, a fixing member 60, and a positioning pin 70. The shaft 30 extends through the can 10, the fixed cam 20, the rotary sliding cam 40, the compression spring 50 and the fixing member 60 in that order, thereby integrating the hinge assembly 100 into a complete unit by means of the positioning pin 70. The compression spring 50 may alternatively be another kind of suitable elastic means such as a resilient cylinder.

The shaft 30 is essentially in the form of a round rod, and includes a pole portion 302, and a discoid head 301 formed at a first end of the pole portion 302. A main part including a second end of the pole portion 302 has a keyed cross-section. The main part of the pole portion 302 thus has two opposite parallel planes 3031 and two opposite arcuate faces 3033 on an outer periphery thereof. A hole 3032 is transversely defined through the second end of the pole portion 302 spanning between the parallel planes 3031.

The can 10 is generally cylindrically shaped, and is partly closed at a first end thereof, and open at an opposite second end thereof. The first end is provided with a generally annular board 103. A through hole 1031 is defined in a center of the board 103. The can 10 has two opposite parallel walls 102 and two opposite arcuate walls 104, thereby defining a cavity 101 therebetween. The can 10 is engaged with the cover 300 of the foldable electronic device so that the can 10 is rotatable with the cover 300.

The fixed cam 20 includes a first tubular portion 201, a second tubular portion 202, and a third tubular portion 203 functioning as an engagement means of the cam 20. The three tubular portions 201, 202, 203 are each essentially in the form of a hollow cylinder, are coaxial with each other, and have a common central hole 204. The hole 204 movably receives the pole portion 302 of the shaft 30, so that the fixed cam 20 is rotatable relative to the shaft 30.

The first tubular portion 201 has two opposite arcuate surfaces and two opposite parallel planes on an outer periphery thereof. The shape and size of the first tubular portion 201 corresponds to that of the cavity 101 of the can 10, so that when the first tubular portion 201 is received in the cavity 101, the first tubular portion 201 is rotatable with the can 10. A pair of opposite projections 2011 is formed at one end of the first tubular portion 201, thereby forming a cam face.

The second tubular portion 202 interconnects the first tubular portion 201 and the third tubular portion 203. An outer diameter of the second tubular portion 202 is less than that of both the first tubular portion 201 and the third tubular portion 203, thereby defining an annular groove (not labeled).

The third tubular portion 203 is made of an elastic material, and includes four arcuate blocks (not labeled) extending along an axial direction from one end of the second tubular portion 202. The four blocks are arranged in the form of a ring, which has a diameter larger than a diameter of the second tubular portion 202. The four blocks are symmetrically opposite from each other and uniformly spaced apart. Four arcuate protrusions 2031 extend along the axial direction from outer edge portions of the four blocks respectively. Each arcuate protrusion 2031 has a beveled outer surface. A receiving cavity (not labeled) is defined between the four arcuate protrusions 2031 and the four blocks, for receiving the head 301 of the shaft 30.

The rotary sliding cam 40 includes a first tubular portion 401 with a larger outer diameter, and a second tubular portion 402 with a smaller outer diameter. The two tubular portions 401, 402 are coaxially arranged and have a common cavity 403. The cavity 403 slidably receives the keyed main part of the pole portion 302 of the shaft 30, so that the rotary sliding cam 40 is rotatable with the shaft 30 and axially movable relative to the shaft 30. A pair of opposite peak portions 4041 and a pair of opposite concave portions 4042 is defined at a same end of the first tubular portion 401, thereby forming a cam face. The cam face of the rotary sliding cam 40 engages with the cam face of the fixed cam 20.

The fixing member 60 includes a first portion 601 with a smaller outer diameter, and a second portion 602 with a larger outer diameter. The two portions 601, 602 are coaxially arranged and have a common cavity 603. The second portion 602 is polygonal, and is engaged with the body 200 of the foldable electronic device so that the fixing member 60 is rotatable with the body 200. A pair of aligned pin holes 604 is transversely defined through the second portion 602, the pin holes 604 being exposed at two opposite parallel planes of the second portion 602 respectively.

In assembly of the hinge assembly 100, the third tubular portion 203 of the fixed cam 20 is extended through the hole 1031 of the can 10. The fixed cam 20 is thus fixed with the can 10, by means of the board 103 of the can 10 being secured in the annular groove of the fixed cam 20. The second end of the shaft 30 is extended through the hole 204 of the fixed cam 20, the cavity 101 of the can 10, the cavity 403 of the rotary sliding cam 40, the compression spring 50, and the cavity 603 of the fixing member 60, thereby integrating the hinge assembly 100 into a complete unit. The head 301 of the shaft 30 is received in the receiving cavity of the fixed cam 20. The first tubular portion 201 of the fixed cam 20, the rotary sliding cam 40 and the compression spring 50 are received in the cavity 101 of the can 10. The fixed cam 20 is rotatable with the can 10, and is rotatable relative to the shaft 30. The cam face of the fixed cam 20 is engaged with the cam face of the rotary sliding cam 40. The fixing member 60 is fixed at the second end of the shaft 30, by means of the positioning pin 70 being secured in the pin holes 604 of the fixing member 60 and the hole 3032 of the shaft 30. The rotary sliding cam 40 is rotatable with the shaft 30 and the fixing member 60, and is movable axially along the shaft 30. The compression spring 50 is elastically engaged around the second tubular portion 402, the second end of the shaft 30 and the first portion 601 of the fixing member 60, between the first tubular portion 401 of the rotary sliding cam 40 and the second portion 602 of the fixing member 60, and continuously presses the rotary sliding cam 40 against the fixed cam 20. The hinge assembly 100 is thus completely assembled, as shown in FIG. 4.

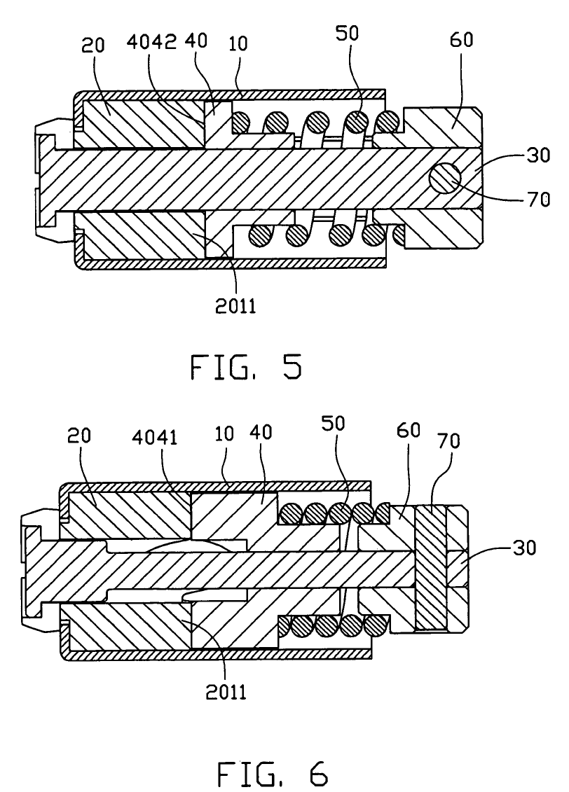

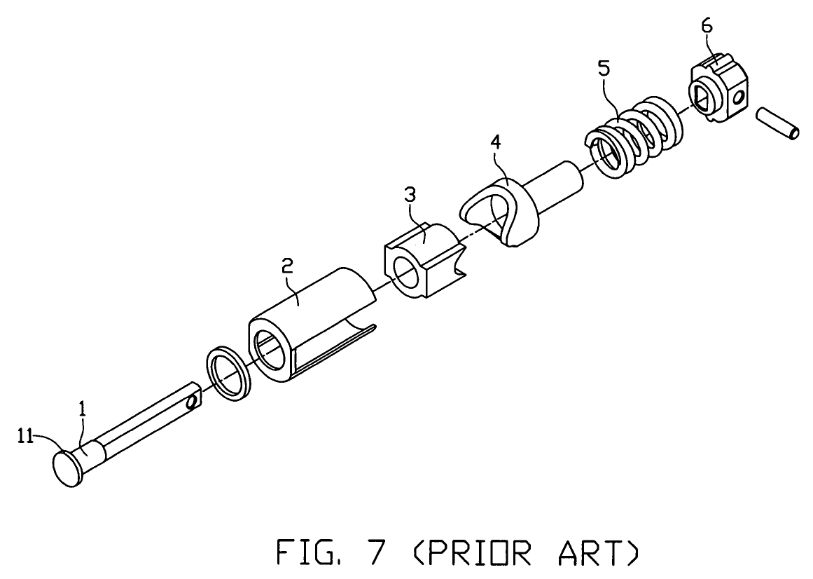

Referring to FIGS. 1 and 4-6, when the projections 2011 of the fixed cam 20 are engaged in the concave portions 4042 of the rotary sliding cam 40, the cover 300 of the foldable electronic device is held in a fully closed position. To open the foldable electronic device, the cover 300 is manually rotated up from the body 200. The can 10 and hence the fixed cam 20 are rotatable relative to the fixing member 60, the shaft 30 and the rotary sliding cam 40. The projections 2011 of the fixed cam 20 move out from engagement with the concave portions 4042 of the rotary sliding cam 40 to the peak portions 4041 of the rotary sliding cam 40. In this process, the rotary sliding cam 40 axially moves away from the fixed cam 20, and compresses the compression spring 50. When the projections 2011 ride over the peak portions 4041, the compression spring 50 decompresses and drives the rotary sliding cam 40 to move axially toward the fixed cam 20 and to continuously rotate relative to the fixed cam 20 until the projections 2011 are engaged in the concave portions 4042 again. The cover 300 is thus opened automatically to a fully open position. The process of closing the cover 300 is substantially the reverse of the above-described opening process.

It is believed that the present embodiments and their advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

We claim:

1. A hinge assembly for a foldable electronic device, comprising:
a can having a center cavity and a board provided at one end thereof;
a fixed cam having a central hole, and a groove defined in a periphery thereof, the fixed cam being partly received in the can with the board of the can being engaged in the groove;
a sliding cam abutting the fixed cam and being movably engaged therewith, the sliding cam defining a center cavity;
a fixing member;
a spring member interposed resiliently between the sliding cam and the fixing member; and
a shaft having a first end, the shaft extending through the hole of the fixed cam, the cavity of the can, the cavity of the sliding cam and the spring member, the first end being engaged with the fixed cam, and the fixing member being fixed to an opposite second end of the shaft.

2. The hinge assembly as claimed in claim 1, wherein the shaft is essentially in the form of a round rod, and comprises a pole portion and a head formed at the first end.

3. The hinge assembly as claimed in claim 2, wherein a part of the pole portion including the second end of the shaft has a keyed cross-section, whereby said part of the pole portion has two opposite parallel planes and two opposite arcuate faces.

4. The hinge assembly as claimed in claim 3, wherein the second end of the pole portion transversely defines a hole spanning between the parallel planes.

5. The hinge assembly as claimed in claim 4, wherein the fixing member comprises a first portion with a smaller outer diameter, and a second portion with a larger outer diameter, and the first and second portions are coaxially arranged and have a common cavity.

6. The hinge assembly as claimed in claim 5, wherein the second portion of the fixing member transversely defines a pin hole.

7. The hinge assembly as claimed in claim 6, further comprising a positioning pin engaging in the pin hole of the fixing member and the hole of the shaft.

8. The hinge assembly as claimed in claim 2, wherein the fixed cam comprises a first tubular portion, a second tubular portion and a third tubular portion, and the three tubular portions are each essentially in the form of a hollow cylinder, are coaxial with each other, and have a common central hole.

9. The hinge assembly as claimed in claim 8, wherein the hole of the fixed cam receives the pole portion of the shaft, so that the fixed cam is rotatable relative to the shaft.

10. The hinge assembly as claimed in claim 8, wherein the first tubular portion has two opposite arcuate faces and two opposite parallel planes on a periphery thereof, and the shape and size of the first tubular portion are such that when the first tubular portion is engagingly received in the cavity of the can, the first tubular portion is rotatable with the can.

11. The hinge assembly as claimed in claim 8, wherein the second tubular portion of the fixed cam interconnects the first tubular portion and the third tubular portion of the fixed cam, and the second tubular portion has an outer diameter less than that of both the first tubular portion and the third tubular portion, thereby defining the groove of the fixed cam.

12. The hinge assembly as claimed in claim 8, wherein the third tubular portion of the fixed cam comprises a plurality of blocks extending in an axial direction from one end of the second tubular portion.

13. The hinge assembly as claimed in claim 12, wherein an arcuate protrusion extends axial from each of the blocks of the third tubular portion of the fixed cam.

14. The hinge assembly as claimed in claim 13, wherein the arcuate protrusion of the third tubular portion has a beveled outer surface, and the arcuate protrusions and the blocks of the third tubular portion define a receiving cavity receiving the head of the shaft.

15. The hinge assembly as claimed in claim 1, wherein the board of the can is annular, and defines a through hole in a center thereof.

16. The hinge assembly as claimed in claim 1, wherein the sliding cam comprises a first tubular portion with a larger outer diameter, and a second tubular portion with a smaller outer diameter, and the two tubular portions are coaxially arranged and cooperatively define the cavity of the sliding cam.

17. The hinge assembly as claimed in claim 16, wherein the cavity of the sliding cam movably receives the first end of the shaft, so that the sliding cam is rotatable with the shaft and axially movable relative to the shaft.

18. A foldable electronic device, comprising:
a cover;
a body; and
a hinge assembly rotatably connecting the cover and the body, the hinge assembly comprising:
a can engaged with one of the cover and the body;
a fixed cam provided partly in the can and engaged therewith;
a sliding cam facing the fixed cam and slidable relative thereto;
a fixing member engaged with the other of the cover and the body;
an elastic member interposed resiliently between the sliding cam and the fixing member; and
a shaft, one end of which is engaged with the fixed cam, the fixed cam being rotatable relative to the shaft, the sliding cam being rotatable with the shaft and being axially movable along the shaft, with an opposite end of the shaft being fixed to the fixing member.

19. An electronic device comprising:
a body functioning as a part of said electronic device;
a cover functioning as another part of said electronic device and capable of being movable relative to said body between a first position thereof where said cover abuts against a side of said body to cover thereon and a second position thereof where said cover moves away from said side of said body to expose said side therefrom; and
a hinge assembly disposed between said body and said cover so as to guidably control movement of said cover between said first and second positions thereof, said hinge assembly comprising a can engagably movable with one of said cover and said body, and a shaft engagably movable with the other of said cover and said body and extendable in said can, a cam receivably formed in said can and having at least one engagement means engagable with said can to position said cam onto said can in order to prohibit said cam from moving relative to said can, interaction of said cam and said shaft in said can capable of guidably controlling said movement of said cover relative to said body.

20. The electronic device as claimed in claim 19, wherein a discoid head is formed at an end of said shaft and capable of engaging with said at least one engagement means of said cam so as to enhance positioning function of said at least one engagement means to position of said cam onto said can.
